(19) United States
(12) Patent Application Publication
(10) Pub. No.: US 2023/0138639 A1
(43) Pub. Date: May 4, 2023

(54) PROCESS FOR PREPARING SILYLATED IONIC COPOLYURETHANES WITH IMPROVED ELASTICITY

(71) Applicant: BOSTIK SA, COLOMBES (FR)

(72) Inventors: Régis GUILLOTTE, Venette (FR); Boris COLIN, Venette (FR)

(21) Appl. No.: 18/050,090

(22) Filed: Oct. 27, 2022

(30) Foreign Application Priority Data
Nov. 4, 2021 (FR) 2111744

(51) Int. Cl. C08G 18/83; C08G 18/75; C08G 18/48; C08G 18/10; C09J 175/08

(52) U.S. Cl. CPC C08G 18/837; C08G 18/757; C08G 18/4825; C08G 18/10; C09J 175/08; C08K 3/346

(57) ABSTRACT

A process for preparing ionic silylated copolyurethanes comprising two ureido-alkylene-alkoxysilane end groups, comprises: (i) forming a composition of copolyurethanes having—NCO end groups by carrying out a polyaddition reaction between a polyisocyanate, a carboxylic diol and a polyol composition comprising a polyol having an Mn of greater than or equal to 2500 g/mol and a polyol having an Mn of less than 2500 g/mol; (ii) neutralizing the formed product with a tertiary amine; and (iii) reacting with an aminosilane derived from a secondary amine. A composition of ionic silylated copolyurethanes comprising two ureido-alkylene-alkoxysilane end groups, said composition being able to be obtained by means of the process. A crosslinkable adhesive and/or sealant composition comprising the composition and a filler.

### CROSS-REFERENCE TO RELATED APPLICATIONS

This application claims the benefit of French Patent Application No. 2111744, filed on Nov. 4, 2021.

### FIELD OF THE INVENTION

The present invention relates to a process for preparing a composition of silylated ionic copolyurethanes having improved elastic properties, in particular a higher elongation at break. A subject of the present invention is also the composition of silylated ionic copolyurethanes which is able to be obtained by means of said process. Finally, the invention relates to an adhesive and/or sealant crosslinkable composition, comprising said copolyurethane composition, and a process for assembling two substrates using said composition.

### TECHNICAL BACKGROUND

Silylated polyurethanes are included, in combination with a mineral filler, in sealant compositions which are among the most popular on the market. Said compositions have in fact the advantage of being free of isocyanates, in particular of monomeric diisocyanates. These compositions thus constitute an alternative, which is preferred from a toxicological viewpoint, to the compositions based on polyurethane having isocyanate end groups.

Said silylated polyurethanes are often described as “prepolyurethanes” since they have alkoxysilane reactive groups, which are generally end groups, and which react with water from the moisture in the air or from the substrates to be assembled, at the time the sealant is used.

This reaction, called crosslinking, therefore takes place in the presence of moisture, by hydrolysis of the alkoxysilane groups borne by the prepolymer, followed by their condensation to form a siloxane bond (—Si—O—Si—) which unites the prepolymer chains to form a three-dimensional polymer network.

The completion of this crosslinking reaction, after a period referred to as “crosslinking time”, therefore has the effect of creating a three-dimensional network within the adhesive seal which unites the substrates to be assembled and which has the desired mechanical properties.

Among these properties, the adhesive seal thus formed must exhibit a great solidity, indicated by a high resistance to deformation. It also must exhibit flexibility (or elasticity) which enables it to adapt to the relative movements of the substrates that it joins, for example under the effect of the dimensional variations induced by changes in temperature or else under the effect of mechanical stresses to which the assembly may be subjected during its lifetime.

The resistance to deformation of a sealant is often quantified, in practice, by the breaking stress (expressed in Pa). The latter is defined simply, in a tensile test on a test specimen consisting of said sealant, as being the stress that needs to be applied to said test specimen in order to achieve breakage thereof.

The elasticity of a sealant for its part is generally represented by a measurement of the elongation at break (expressed in %), which is defined in the abovementioned tensile test as the elongation measured for said test specimen at the moment at which it breaks.

The most well-known silylated polyurethanes are generally prepared by a two-step process.

The 1st step consists in forming a polyurethane having isocyanate end groups, by carrying out a reaction for polyaddition of a polyether diol (in particular a poly(propylene glycol)) with a polyisocyanate (preferably a diisocyanate).

The second step consists in reacting the prepolyurethane thus obtained with an aminosilane comprising at least one alkoxysilane group so as to obtain a polyurethane main chain which comprises two alkoxysilane end groups each linked to said chain by way of a urea function.

The silylated polyurethanes obtained by this 2-step process will hereinafter be denoted “SPUR”.

However, the crosslinking time for these silylated polyurethanes, in particular these SPURs, needs to be accelerated in order to meet the users' needs, and it is obligatory to this end to incorporate a crosslinking catalyst in the sealant compositions comprising these silylated polyurethanes, in particular these SPURs.

Generally, the crosslinking catalyst included in sealant or adhesive compositions based on silylated polymers, in particular on SPURs, is a metal catalyst, and more particularly a tin-based catalyst such as dibutyltin dilaurate (DBTDL), dibutyltin diacetate or dibutyltin bis(acetylacetonate) or dioctyltin bis(acetylacetonate). However, these catalysts are the subject of criticism with respect to their toxicity or to their impact on the environment, which leads to the manufacturers concerned limiting or even avoiding their use, especially when these metal catalysts remain in the adhesive seal once the composition has been crosslinked.

Organic crosslinking catalysts derived from nitrogen-containing heterocycles such as 1,8-diazabicyclo[5.4.0]undec-7-ene (also called DBU) or else 1,5,7-triazabicyclo[4.4.0]dec-5-ene (also called TBD) have been used as an alternative to the metal catalysts, especially to the tin-based catalysts. However, they have the drawback of causing a colour change in the adhesive seal, generally towards yellow, which is attributed to their migration to the surface of said seal.

An ionic silylated copolyurethane comprising two ureido-alkylene-alkoxysilane end groups is known from application WO 2021/079063.

Such a copolyurethane is prepared by means of a process derived from the process for producing SPURs recalled above, in which the 1st step is modified so as to form a copolyurethane having isocyanate end groups, by reacting with the diisocyanate, besides the poly(propylene glycol), a carboxylic diol. The pendant carboxylic groups of the copolyurethane thus obtained are then neutralized with an amine, before use of the aminosilane as indicated in the second step of the process for producing SPURs.

The copolyurethane taught by this PCT application advantageously leads to crosslinkable sealant and/or adhesive compositions which have, in the absence of catalyst, in particular in the absence of tin-based catalyst, a reduced crosslinking time compared to the SPURs of the prior art. In addition, the adhesive seal which is formed by the crosslinking in the presence of moisture of an adhesive and/or sealant crosslinkable composition comprising said copolyurethane and at least one mineral filler also has better mechanical properties, and in particular improved resistance to deformation and improved elasticity, respectively indicated by increased breaking stress and elongation at break.

However, this elongation at break does not generally exceed 100%, which can prove insufficient from the viewpoint of the expected performance results of sealants in the construction field or in certain industrial fields such as the attachment by bonding of car windscreens, in the automobile industry.

Indeed, in the modern technology of building construction for example, sealants are widely used to join (or assemble or bond together) the most diverse substrates, for example substrates made of steel or concrete or of other porous materials which have an uneven surface and are permeable and brittle. These sealants must offer adequate elasticity properties, in order to follow with flexibility the movements of the adhesive seal caused by the relative movements of the substrates between which they have been applied, under the effect of the various external factors, such as outside temperature or ground movement.

Thus, the aim of the present invention is to provide ionic silylated copolyurethanes, the crosslinking of which in combination with a mineral filler in a sealant composition has the effect of forming an adhesive seal which exhibits a better elongation at break, in particular an elongation at break greater than or equal to 100%, while at the same time maintaining its other features at acceptable levels.

Another aim of the invention is to overcome the drawbacks of the silylated polyurethanes known in the prior art, in particular the drawbacks of the SPURs.

Another aim of the invention is to propose silylated polyurethanes the crosslinking of which does not require, or substantially does not require, a tin-based catalyst or organic catalyst derived from a nitrogen-containing heterocycle.

Another aim of the invention is to propose a silylated polyurethane which can crosslink in the absence of catalyst.

Another aim of the invention is to propose a sealant composition based on silylated polyurethanes which makes it possible, without the addition, or without the substantial addition, of catalyst, to reduce the crosslinking time.

Another aim of the invention is to propose a silylated polyurethane-based sealant composition, producing an adhesive seal which has improved breaking stress properties, in particular a breaking stress of at least 3 MPa.

It has been found that these aims can be achieved, in whole or in part, by means of the composition of silylated copolyurethanes having alkoxysilane end groups, for which the preparation process is as described below.

### DESCRIPTION OF THE INVENTION

Preparation Process:

The subject of the present invention is, first of all, a process for preparing a composition of ionic silylated copolyurethanes comprising two ureido-alkylene-alkoxysilane end groups, said process comprising successively:
a step (i) of forming a composition of copolyurethanes having —NCO end groups by carrying out a polyaddition reaction between:
   a polyisocyanate (A) of formula (iA):

OCN—R¹—NCO (iA)
in which R¹ represents a divalent hydrocarbon radical comprising from 5 to 45 carbon atoms and which may be aromatic or aliphatic, linear, branched or cyclic, and may include at least one heteroatom chosen from O, S and N;
a composition (B) of polyols comprising:
   at least one polyol (B1) with a number-average molecular mass (Mn) of greater than or equal to 2500 g/mol; and
   at least one polyol (B2) with a number-average molecular mass (Mn) of less than 2500 g/mol; and
a carboxylic diol (C) of formula (iC):

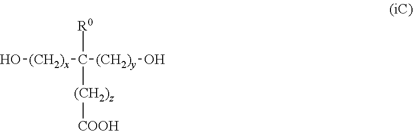

in which:
   R⁰ represents a hydrogen atom or an alkyl radical comprising from 1 to 18 carbon atoms;
   x and y, which may be identical or different, are integers ranging from 1 to 8; and
   z is an integer ranging from 0 to 8; then
a step (ii) of reacting the composition of copolyurethanes formed in step (i) with an amine (D) of formula (iiD):

N(R)(R′)(R″) (iiD)
in which:
   R, R′ and R″, which may be identical or different, each represent a saturated, unsaturated or aromatic hydrocarbon radical, optionally comprising a heteroatom chosen from N, O and S;
   R, R′ and R″ furthermore being such that said tertiary amine (D) is a linear, branched or cyclic amine or polyamine the number-average molar mass Mn of which ranges from 59 to 6000 g/mol and which has a pKa of greater than 8; then
a step (iii) of reacting the composition of copolyurethanes having —NCO end groups formed in step (ii) with an aminosilane (E) derived from a secondary amine, of formula (iiiE)

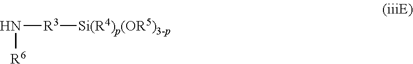

in which:
   R³ represents a linear or branched divalent alkylene radical comprising from 1 to 6 carbon atoms;
   R⁴ represents a linear or branched alkyl radical comprising from 1 to 4 carbon atoms;
   R⁵ represents a linear or branched alkyl radical comprising from 1 to 4 carbon atoms, an alkylcarbonyl radical comprising from 2 to 8 carbon atoms, or a dialkylimino radical comprising from 3 to 8 carbon atoms; and
   p is an integer equal to 0, 1 or 2;
   R⁶ represents a phenyl radical, a linear, branched or cyclic alkyl radical comprising from 1 to 6 carbon atoms, or a radical chosen from the radicals:
      of formula (IIc):

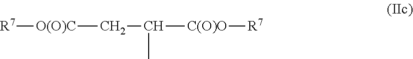

of formula (IId):

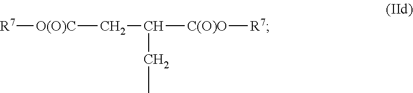

of formula (IIe):

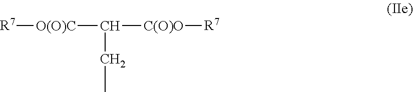

in which R⁷ is a linear or branched alkyl radical comprising from 1 to 6 carbon atoms;
of formula (IIf):

—CH₂—COO³¹ , HN⁺(R)(R′)(R″) (IIf); and
of formula (IIg):

—CH₂—CH₂—COO⁻, HN⁺(R)(R′)(R″) (IIg)
in which R, R′ and R″ are the radicals as defined above.

It has presently been found that the implementation of the process according to the invention results in the formation of a new silylated ionic copolyurethane, which is in the form of a composition, the combination of which with a mineral filler results in a crosslinkable sealant and/or adhesive composition which has, in the absence of catalysts, a crosslinking time that is advantageously comparable to that of the silylated ionic copolyurethane taught by WO 2021/079063. Furthermore, the adhesive seal resulting from the crosslinking of said composition exhibits a resistance to deformation quantified by a tensile breaking stress of at least 3 Mpa, corresponding to the expected solidity of an adhesive seal for the building industry or in the industrial fields of interest. Finally, said adhesive seal has an elongation at break of greater than or equal to 100%, even greater than 150%, ranging up to values close to or greater than 200%, therefore very much greater than those of the silylated ionic copolyurethane taught by WO 2021/079063.

In the present text, the average molecular mass Mn is measured by size exclusion chromatography (or SEC), which is also denoted by the term “gel permeation chromatography” (or GPC). The calibration carried out is usually a PEG (PolyEthylene Glycol) or PS (PolyStyrene), preferably PS, calibration.

Step (i):

Polyisocyanate (A):

Step (i) employs the polyisocyanate (A) of formula (iA):

OCN—R¹—NCO (iA)

in which R¹ represents a divalent hydrocarbon radical comprising from 5 to 45 carbon atoms and which may be aromatic or aliphatic, linear, branched or cyclic, and may include at least one heteroatom chosen from O, S and N.

Preferably, the polyisocyanate (A) of formula (iA) is such that the radical R¹ is chosen from one of the following divalent radicals, the formulae of which below show the two free valencies:
a) the divalent radical derived from isophorone diisocyanate (IPDI):

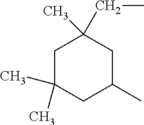

b) the divalent radical derived from dicyclohexylmethane 4,4′- and 2,4′-diisocyanate (HMDI):

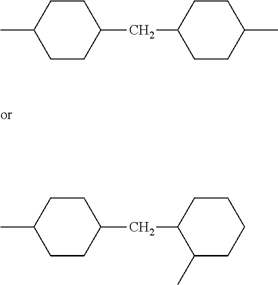

c) the radical derived from toluene 2,4- and 2,6-diisocyanate (TDI):

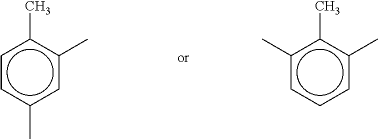

d) the radical derived from diphenylmethane 4,4′- and 2,4′-diisocyanate (MDI):

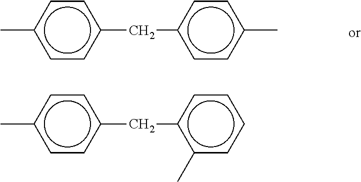

e) the radical derived from m-xylylene diisocyanate (m-XDI):

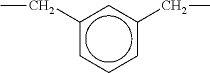

f) the radical derived from hexamethylene diisocyanate (HDI):

—(CH₂)₆—
g) the divalent group derived from a hexamethylene diisocyanate (HDI) allophanate of formula (iA′):

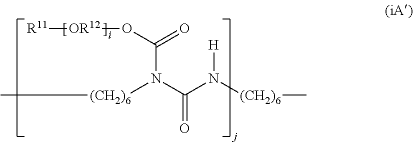

in which:
i is an integer ranging from 2 to 5;
j is an integer ranging from 1 to 2;
R¹¹ represents a saturated or unsaturated, cyclic or acyclic, linear or branched hydrocarbon radical comprising from 6 to 14 carbon atoms;
R¹² represents a divalent propylene group;
i, j, R¹¹ and R¹² being such that the hexamethylene diisocyanate allophanate corresponding to the formula (iA′) comprises a content of isocyanate groups NCO ranging from 12% to 14% by weight, relative to the weight of said allophanate.

Polyisocyanates the radical R¹ of which corresponds to the radicals a) to f) above are well known to those skilled in the art and are widely available commercially. A polyisocyanate the radical R¹ of which corresponds to the divalent group g) above is also sold under the “Tolonate®” name, by Vencorex, for example under the name “Tolonate® X FLO 100”.

According to a particularly preferred variant of the process according to the invention, the polyisocyanate (A) is isophorone diisocyanate (IPDI).

Polyol Composition (B):

Step (i) employs a polyol composition (B) comprising:
at least one polyol (B1) with a number-average molecular mass (Mn) of greater than or equal to 2500 g/mol, and
at least one polyol (B2) with a number-average molecular mass (Mn) of less than 2500 g/mol.

According to one embodiment, the polyol composition (B) consists of said at least one polyol (B1) and of said at least one polyol (B2).

According to one preferred variant, the number-average molecular mass (Mn) of the polyol (B1) is within a range extending from 2500 g/mol to 20000 g/mol, more preferentially ranging from 3000 g/mol to 15000 g/mol, in particular from 3200 g/mol to 9000 g/mol, even more preferentially ranging from 3000 g/mol to 5000 g/mol, in particular from 3200 g/mol to 5000 g/mol.

According to another preferred variant, the number-average molecular mass Mn of the polyol (B2) is greater than or equal to 200 g/mol and less than 2500 g/mol, and even more preferably is within a range extending from 200 g/mol to 2250 g/mol.

The polyol competition (B) advantageously comprises (or consists of):
10 mol % to 90 mol % of the polyol (B1), and
10 mol % to 90 mol % of of the polyol (B2),

said mole percentages being expressed on the basis of the total number of moles of (B1) and (B2) present in the composition (B).

When the polyol composition (B) comprises (or consists of) several polyols (B1) and/or several polyols (B2), it is understood that the molar percentage ranges previously indicated apply, respectively, to the total number of moles of the polyols (B1) and/or to the total number of moles of the polyols (B2).

Preferably, the polyol composition (B) advantageously comprises (or consists of):
10 mol % to 70 mol % of the polyol (B1), and
30 mol % to 90 mol % of the polyol (B2),

said mole percentages being expressed on the basis of the total number of moles of (B1) and (B2) present in the composition (B).

According to one even more preferred variant, the polyol composition (B) consists of from 10 mol % to 35 mol % of the polyol(s) (B1) and from 65 mol % to 90 mol % of the polyol(s) (B2), and even more preferentially from 15 mol % to 30 mol % of (B1) and from 70 mol % to 85 mol % of (B2). It has been found that the composition of silylated ionic copolyurethanes formed by the process according to the invention corresponding to such a composition (B) results, after use in a sealant and/or adhesive composition, in an adhesive seal the elongation at break of which is very advantageously greater than 200%.

According to one most particularly preferred embodiment, the polyol composition (B) comprises (or consists of), besides the polyol (B1) as defined above, two polyols (B2) which are chosen, respectively, from:
a first polyol (B2-1) having a number-average molecular mass Mn of greater than or equal to 1250 g/mol and less than 2500 g/mol, preferably between 1250 g/mol and 2250 g/mol, and
a second polyol (B2-2) having a number-average molecular mass Mn ranging from 200 g/mol to 1000 g/mol, and even more preferentially ranging from 500 g/mol to 1000 g/mol.

In accordance with the latter embodiment, the polyol composition (B) then comprises (or consists of), preferably:
from 15 mol % to 45 mol % of the polyol (B1),
from 10 mol % to 25 mol % of the polyol (B2-1), and
from 30 mol % to 70 mol % of the polyol (B2-2),

said mole percentages being expressed on the basis of the total number of moles of (B1) and (B2) present in the composition (B).

The polyols included in the composition (B), and in particular the polyols (B1) and (B2), can have a hydroxyl functionality ranging from 2 to 6, preferably 2 to 4, and even more preferentially from 2 to 3. In the context of the invention, and unless otherwise mentioned, the hydroxyl functionality of a polyol is the mean number of hydroxyl functions per mole of polyol.

According to one preferred variant, said polyols have a hydroxyl functionality equal to 2.

The polyols that can be used in the composition (B), and in particular the polyols (B1) and (B2), can be chosen from polyester polyols, polyether polyols, polydiene polyols, polycarbonate polyols and poly(ether-carbonate) polyols. The polyols that can be used can also be chosen from aliphatic polyols, arylaliphatic polyols and aromatic polyols.

Among the polyester polyols, mention may for example be made of:
polyester polyols of natural origin, such as castor oil;
polyester polyols resulting from the condensation:
   of one or more aliphatic (linear, branched or cyclic) or aromatic polyols, such as, for example, ethanediol, propane-1,2-diol, propane-1,3-diol, glycerol, trimethylolpropane, hexane-1,6-diol, hexane-1,2,6-triol, butenediol, cyclohexanedimethanol, sucrose, glucose, sorbitol, glycerol, trimethylolpropane, pentaerythritol, mannitol, triethanolamine, N-methyldiethanolamine and mixtures thereof, with
   one or more polycarboxylic acids or an ester or anhydride derivative thereof, such as 1,6-hexanedioic acid, dodecanedioic acid, azelaic acid, sebacic acid, adipic acid, 1,18-octadecanedioic acid, phthalic acid, succinic acid and the mixtures of these acids, an unsaturated anhydride, such as, for example, maleic or phthalic anhydride, or a lactone, such as, for example, caprolactone.

The abovementioned polyester polyols may be prepared conventionally and are for the most part commercially available.

Among the polyester polyols, mention may for example be made of the following products with a hydroxyl functionality equal to 2:
Tone® 0240 (sold by Union Carbide), which is a polycaprolactone with a number-average molecular mass Mn of approximately 2000 g/mol and a melting point of approximately 50° C.,
Dynacoll® 7381 (sold by Evonik) with a number-average molecular mass Mn of approximately 3500 g/mol and having a melting point of approximately 65° C.,
Dynacoll® 7360 (sold by Evonik), which results from the condensation of adipic acid with hexanediol and has a number-average molecular mass Mn of approximately 3500 g/mol and a melting point of approximately 55° C.,
Dynacoll® 7330 (sold by Evonik) with a number-average molecular mass Mn of approximately 3500 g/mol and having a melting point of approximately 85° C.,
Dynacoll® 7363 (sold by Evonik), which also results from the condensation of adipic acid with hexanediol and has a number-average molecular mass Mn of approximately 5500 g/mol and a melting point of approximately 57° C.,
Dynacoll® 7250 (sold by Evonik): polyester polyol having a viscosity of 180 Pa·s at 23° C., a number-average molecular mass Mn equal to 5500 g/mol and a Tg equal to −50° C.,
Kuraray® P-6010 (sold by Kuraray): polyester polyol having a viscosity of 68 Pa·s at 23° C., a number-average molecular mass equal to 6000 g/mol and a Tg equal to −64° C.,
Kuraray® P-10010 (sold by Kuraray): polyester polyol having a viscosity of 687 Pa·s at 23° C. and a number-average molecular mass equal to 10000 g/mol; and
Realky XTR 10140 (sold by Cray Valley) having a number-average molecular mass in the vicinity of 1000 g/mol.

The polyether polyols which can be used in the composition (B), and in particular the polyols (B1) and (B2), are preferably chosen from polyoxyalkylene polyols, the linear or branched alkylene part of which comprises from 1 to 4 carbon atoms, preferably from 2 to 3 carbon atoms.

More preferentially, the polyether polyols which can be used according to the invention are preferably chosen from polyoxyalkylene diols or polyoxyalkylene triols and even better still polyoxyalkylene diols, the linear or branched alkylene part of which comprises from 1 to 4 carbon atoms, preferably from 2 to 3 carbon atoms.

As examples of polyoxyalkylene diols or triols which can be used according to the invention, mention may for example be made of:
polyoxypropylene diols or triols (also denoted polypropylene glycol (PPG) diol or triol),
polyoxyethylene diols or triols (also denoted polyethylene glycol (PEG) diol or triol),
polyoxybutylene diols or triols (also denoted polybutylene glycol (PBG) diol or triol),
copolymers or terpolymers of PPG/PEG/PBG diol or triol,
polytetrahydrofuran (PolyTHF) diols or triols,
polytetramethylene glycols (PTMG) having a number-average molecular mass ranging from 200 g/mol to 12000 g/mol,

Preferably, the polyether polyols included in the composition (B) are chosen from polyoxypropylene diols. The polyether polyols mentioned above can be prepared conventionally and are widely available commercially. They can, for example, be obtained by polymerization of the corresponding alkylene oxide in the presence of a catalyst based on a double metal/cyanide complex.

By way of examples of polyether diols, mention may be made of polyoxypropylene diols sold under the name Acclaim® by Covestro, such as:
Acclaim® 18200 having a number-average molecular mass in the vicinity of 18700 g/mol,
Acclaim® 12200 having a number-average molecular mass in the vicinity of 11335 g/mol,
Acclaim® 8200 having a number-average molecular mass in the vicinity of 8057 g/mol, and
Acclaim® 4200 having a number-average molecular mass in the vicinity of 4020 g/mol, or else
the polyoxypropylene diol sold under the name Voranol P2000 by Dow, having a number-average molecular mass in the vicinity of 2004 g/mol, and
Voranol® EP 1900 which is a difunctional PPG having a number-average molecular mass of approximately 4008 g/mol.

Mention may be made, as examples of polyether triols, of:
the polyoxypropylene triol sold under the name Voranol® CP3355 by Dow, having a number-average molecular mass in the vicinity of 3554 g/mol,
Voranol® CP 755 which is a trifunctional PPG having a number-average molecular mass of approximately 710 g/mol; or else
Acclaim® 6300 which is a trifunctional PPG having a number-average molecular mass in the vicinity of 5948 g/mol.

By way of examples of polytetramethylene glycols (PTMG) with a hydroxyl functionality equal to 2, mention may be made of:
Terathane® 1000, the Mn of which is in the vicinity of 1000 g/mol,
Terathane® 650, the Mn of which is in the vicinity of 650 g/mol, and
Terathane® 250, the Mn of which is in the vicinity of 250 g/mol.

The polydiene polyols which can be used in the composition (B) and in particular the polyols (B1) and (B2), are chosen from polybutadienes comprising hydroxyl end groups, which are optionally hydrogenated or epoxidized. Preferentially, said polybutadienes are chosen from butadiene homopolymers and copolymers comprising hydroxyl end groups, which are optionally hydrogenated or epoxidized.

The abovementioned hydrogenated derivatives may be obtained by complete or partial hydrogenation of the double bonds of a polydiene comprising hydroxyl end groups, and are thus saturated or unsaturated.

The abovementioned epoxidized derivatives may be obtained by chemoselective epoxidation of the double bonds of the main chain of a polydiene comprising hydroxyl end groups, and thus comprise at least one epoxy group in their main chain.

As examples of polybutadiene polyols, mention may be made of saturated or unsaturated butadiene homopolymers comprising hydroxyl end groups which are optionally epoxidized, such as, for example, those sold under the name Poly bd® or Krasol® by Cray Valley.

Examples of polycarbonate diols that may be mentioned include:
Converge Polyol 212-10 and Converge Polyol 212-20 sold by Novomer, respectively having number-average molecular masses (Mn) equal to 1000 and 2000 g/mol,
Desmophen® C XP 2716, sold by Covestro, having a number-average molecular mass (Mn) equal to 326 g/mol,
Polyol C-590, C1090, C-2090 and C-3090, sold by Kuraray, having a number-average molecular mass (Mn) ranging from 500 to 3000 g/mol.

The polyols which can be used in the composition (B), and in particular the polyols (B1) and (B2), can further be chosen from biobased diols such as:
Krasol® F3000 which is a polyfarnesene diol having an Mn equal to 3000 g/mol, sold by Cray Valley,
Pripol® 2033 having an Mn equal to 970 g/mol, sold by Croda.

According to one preferred variant of the process according to the invention, the polyols included in the composition (B), and in particular the polyols (B1) and (B2), are polyether diols.

Carboxylic Diol (C):

Step (i) employs the carboxylic diol (C) of formula (iC):

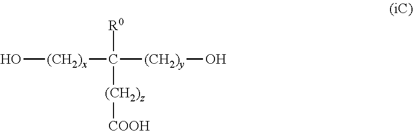

in which:
   R° represents a hydrogen atom or an alkyl radical comprising from 1 to 18 carbon atoms;
   x and y, which may be identical or different, are integers ranging from 1 to 8; and
   z is an integer ranging from 0 to 8.

According to an advantageous variant of the process according to the invention, step (i) employs a carboxylic diol (C) of formula (iC) in which:
R° represents an alkyl radical comprising from 1 to 4 carbon atoms, preferably a methyl, ethyl or n-propyl radical, even more preferentially a methyl radical;
x and y are identical and equal to 1; and/or
z is equal to 0.

Mention may be made, as specific examples of carboxylic diols (C), of the following α,α-dimethylolalkanoic acids:
2,2-di(hydroxymethyl)propionic acid (or DMPA),
2,2-di(hydroxymethyl)butyric acid,
2,2-di(hydroxymethyl)pentanoic acid.

According to a most particularly preferred embodiment, the carboxylic diol (C) employed in step (i) is 2,2-di(hydroxymethyl)propionic acid, also known as α,α-dimethylolpropionic acid (denoted by way of convenience by the acronym DMPA) of formula:

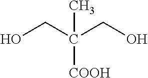

The carboxylic diols (C) of formula (iC) are prepared according to conventional organic synthesis processes, as are described, for example, in the U.S. Pat. No. 3,412,054 from Union Carbide, and many of them, such as DMPA, are commercially available.

In step (i) of the process according to the invention, the polyisocyanate (A), the polyol composition (B) and the carboxylic diol (C) are reacted in amounts corresponding to an excess of the equivalent number of —NCO groups of the polyisocyanate (A) relative to the equivalent number of —OH groups provided by the composition (B) and the diol (C).

Preferably, these amounts correspond to an —NCO/—OH equivalent ratio of between 1.1 and 4.2, preferably between 1.1 and 3.8, more preferentially between 1.1 and 2.

Said ratio is defined as being equal to the equivalent number of —NCO groups of the polyisocyanate (A) divided by the sum of the equivalent numbers of —OH groups provided by the polyol composition (B) and by the carboxylic diol (C).

The amounts by weight of the reactants to be charged into the reactor are determined on the basis of this —NCO/—OH equivalent ratio and from the total hydroxyl number NOH of the composition (B) and the molecular masses of (A) and (C). The hydroxyl number NOH of the polyols (B1) and (B2) included in (or constituting) the composition (B) is the number of hydroxyl functions per gram of polyol, expressed in the form of the equivalent number of milligrams of KOH which are used in the quantitative determination of the hydroxyl functions. The hydroxyl number N_{OH} of a polyol with a functionality f and having a number-average molecular mass Mn can also be deduced from the following formula:

N_{OH}=(56.1*f*1000)/Mn

in which the sign “*” indicates a multiplication.

The relative amounts of the polyol composition (B) and of the carboxylic diol (C) to be introduced into the reactor for reaction in step (i) generally correspond to a molar ratio: number of moles of (C)/number of moles of the polyols included in or constituting (B) (more particularly of the polyols (B1) and (B2)) which can vary within a wide range, possibly ranging from 0.04 to 20, preferably from 0.08 to 0.5, more preferentially from 0.08 to 0.2.

The polyaddition reaction of step (i) is generally carried out in the presence of a catalyst which may be any catalyst known to those skilled in the art for catalysing the formation of polyurethane by reaction of a polyisocyanate and at least one polyol. Such a catalyst is for example chosen from carboxylates of bismuth and/or zinc. As commercially available examples, mention may be made of Borchi® KAT 315 from Borchers GmbH, which is a bismuth neodecanoate; or else Borchi® KAT 15 from this same company, which is a zinc neodecanoate.

Lastly, the polyaddition reaction is generally carried out, under anhydrous conditions, at a temperature of between 60° C. and 120° C.

Step (ii):

Step (ii) consists of reacting the copolyurethane composition formed in step (i) with an amine (D) of formula (iiD):

N(R)(R′)(R″) (iiD)

and corresponds to the neutralization of the pendant —COOH group which is included in the main chain of said copolyurethanes.

In formula (iiD):
R, R′ and R″, which may be identical or different, each represent a saturated, unsaturated or aromatic hydrocarbon radical, optionally comprising a heteroatom chosen from N, O and S; and
R, R′ and R″ furthermore being such that the tertiary amine (D) of formula N(R)(R′)(R″) is a linear, branched or cyclic amine or polyamine the number-average molar mass Mn of which ranges from 59 g/mol to 6000 g/mol and which has a pKa of greater than 8.

According to one embodiment, the tertiary amine (D) is chosen from:
a polyethyleneimine,
a polypropyleneimine,
triethylamine (or TEA, with a pKa equal to 10.75),
1,8-diazabicyclo[5.4.0]undec-7-ene (or DBU) the structural formula of which is:

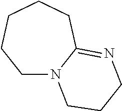 [SMILES: C1CCC2=NCCCN2CC1]

and the pKa of which is equal to 12;
1,4-diazabicyclo[2.2.2]octane (or DABCO), the structural formula of which is:

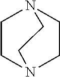

and the pKa of which is equal to 8.87;
1,5-diazabicyclo[4.3.0]non-5-ene (DBN), the structural formula of which is:

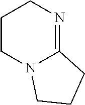

and the pKa of which is equal to 12;
N,N-dicyclohexylmethylamine (or DCHMA), the pKa of which is equal to 11; and
trihexylamine (or THA), the pKa of which is equal to 10.5.

According to a further preferred variant, the pKa of the corresponding amine is greater than or equal to 10.

According to a most particularly preferred variant, the amine (D) is triethylamine (TEA) or trihexylamine (THA).

According to another preferred variant, the amine (D) is chosen from DBU and DABCO. Such an amine is often incorporated as crosslinking catalyst into a sealant and/or adhesive composition comprising an SPUR. In that case, it has the drawback of leading, after crosslinking of said composition, to a yellowing of the adhesive seal, probably linked to its migration to the surface of said seal. In contrast, the incorporation, in step (ii) of the process according to the invention, of such an amine as an agent for neutralizing the pendant carboxylate group has the advantageous effect of an absence of yellowing of the adhesive seal resulting from the crosslinking of the sealant and/or adhesive composition which comprises the composition of ionic silylated copolyurethanes prepared by said process. Such an effect is probably linked to the chemical integration of the corresponding quaternary ammonium into the main chain of said copolyurethanes.

The amine (D) is advantageously introduced in step (ii) in an amount corresponding to a: [number of moles of (D)]/[number of moles of the carboxylic diol (C) introduced in step (i)] molar equivalent ratio which is within a range extending from 0.5 to 2.5, preferably from 0.5 to 2.

The neutralization reaction is advantageously carried out at a temperature within a range extending from 20° C. to 80° C., preferably from 20° C. to 40° C.

Step (iii):

Step (iii) consists of reacting the composition of copolyurethanes having —NCO end groups formed in step (ii) with an aminosilane (E) derived from a secondary amine, of formula (iiiE):

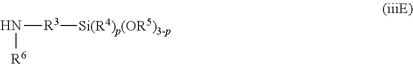

in which:
R³ represents a linear or branched divalent alkylene radical comprising from 1 to 6 carbon atoms;
R⁴ represents a linear or branched alkyl radical comprising from 1 to 4 carbon atoms;
R⁵ represents a linear or branched alkyl radical comprising from 1 to 4 carbon atoms, an alkylcarbonyl radical comprising from 2 to 8 carbon atoms, or a dialkylimino radical comprising from 3 to 8 carbon atoms; and
p is an integer equal to 0, 1 or 2;
R⁶ represents a phenyl radical, a linear, branched or cyclic alkyl radical comprising from 1 to 6 carbon atoms, or a radical chosen from the radicals:
   of formula (IIc):

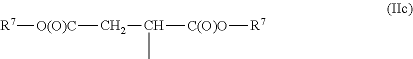

of formula (IId):

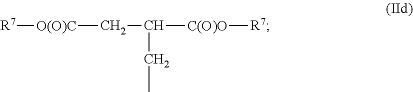

of formula (IIe):

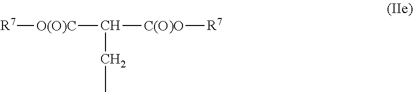

in which R⁷ is a linear or branched alkyl radical comprising from 1 to 6 carbon atoms;
of formula (IIf):

—CH₂—COO⁻, HN⁺(R)(R′)(R″) (IIf); and
of formula (IIg):

—CH₂—CH₂—COO⁻, HN⁺(R)(R′)(R″) (IIg)
in which R, R′ and R″ are the radicals as defined above.

The aminosilanes of formula (iiiE) are widely commercially available.

By way of example, mention may be made of N-(3-(trimethoxysilyl)propyl)butylamine available under the name Dynasylan® 1189 from Evonik, of formula:

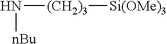

Other aminosilanes of formula (iiiE) are easily obtained by synthesis from commercial products. This is thus the case for the compound named aminotriethoxysilane DEM+A1100 hereinbelow, which corresponds to the formula:

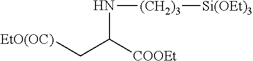

and which is obtained by reacting diethyl maleate with γ-aminopropyltriethoxysilane. The latter compound is available under the name Silquest® A1100 from Momentive and corresponds to the formula:

H₂N—(CH₂)₃—Si(OEt)₃

The aminosilanes of formula (iiiE) in which R⁶ represents a radical of formula (IIf) or (IIg) may be obtained by neutralization, by means of the amine (D) of formula (iiD), of the silylated compounds substituted by an amino acid that are described in the U.S. Pat. No. 9,567,354 in the name of Shin-Etsu Chemical Co., Ltd.

Preferably, in formula (iiiE) of the aminosilane (E):
R³ represents the methylene or n-propylene radical, preferably n-propylene radical;
R⁴ and R⁵, which may be identical or different, each represent the methyl or ethyl radical, preferably methyl radical;
p is equal to 0; and/or
R⁶ represents a linear alkyl radical comprising from 1 to 4 carbon atoms, preferentially n-butyl, or a radical of formula (IIc) in which R⁷ is an alkyl radical comprising from 1 to 3 carbon atoms, R⁷ preferentially being an ethyl radical.

In order to form the composition of ionic silylated copolyurethanes having ureido-alkylene-alkoxysilane end groups, the composition of copolyurethanes having —NCO end groups that is obtained in step (ii) is advantageously reacting, in accordance with (iii), with a substantially stoichiometric amount of the aminosilane (E). The molar amounts of these reactants advantageously correspond to an —NCO/—NH equivalent ratio which is between 0.90 and 1.1, and is preferably equal to about 1.

During this step (iii), reaction of the —NH group of the aminosilane (E) with each of the two —NCO end groups of the copolyurethanes included in the composition formed in step (ii) leads to the formation of a urea function.

Step (iii) is generally carried out, likewise under anhydrous conditions, at a temperature within a range extending from 20° C. to 80° C., preferably from 20° C. to 40° C.

Advantageously, the process according to the invention is carried out in the absence of water as solvent. Thus, the process according to the invention is carried out without the addition of free water, that is to say water other than that inherently included in the ingredients used. In particular, the content of water introduced into the process according to the invention is less than 5% by weight relative to the total weight of the ingredients used, preferably less than 3% by weight, in particular less than 1% by weight.

According to one preferred variant, the process according to the invention is carried out in the presence of a plasticizing agent and/or a solvent that is not water, which is more preferably introduced in step (i).

By way of example of plasticizing agent which can be used, use may be made of any plasticizing agent customarily used in the sealants field. The reduced viscosity obtained through the use of such a plasticizing agent for the composition of ionic silylated copolyurethanes is advantageous for the handling thereof in industrial facilities.

Preferably, use is made of:
diisodecyl phthalate, as sold under the name Palatinol™ DIDP by BASF,
an alkylsulfonic acid ester of phenol, as sold under the name Mesamoll® by Lanxess,
diisononyl 1,2-cyclohexanedicarboxylate, as sold under the name Hexamoll Dinch® by BASF,
pentaerythritol tetravalerate, as sold under the name Pevalen™ by Perstorp,
a polysiloxane resin, in particular a silsesquioxane having a number-average molecular mass ranging from 400 g/mol to 4000 g/mol, preferentially from 500 g/mol to 2500 g/mol, such as Dow Corning® 3074 sold by Dow, the Mn of which is between 1300-1500 g/mol.

By way of example of a usable solvent, use may be made of an aprotic polar solvent, which is preferably chosen from ethyl acetate, tetrahydrofuran (or THF), propylene carbonate, N,N-dimethylformamide (or DMF), acetonitrile (or methyl cyanide) or else dimethyl sulfoxide (or DMSO).

Conversely, water is not considered to be a solvent in the present invention.

The plasticizing agent and/or the solvent are generally introduced in step (i) in a proportion of an amount expressed as % by weight ranging from 5% to 20%, on the basis of the total weight of the reagents used.

According to another variant, the process according to the invention is carried out in the absence of plasticizing agent and/or solvent.

According to another preferred variant, optionally combined with the previous 2, a moisture-absorbing agent (or desiccant) is introduced at the end of step (iii) of the process according to the invention, after reaction of the aminosilane (E) with the composition of copolyurethanes having an —NCO end group, formed in step (ii).

Appropriate moisture-absorbing agents are in particular alkoxysilanes such as trialkoxysilanes (particularly trimethoxysilanes) and alkoxysilanes containing an amino, mercapto or epoxy group. Examples that may be mentioned include vinyltrimethoxysilane (or VTMO), gamma-glycidyloxypropyltrimethoxysilane, N-beta-(aminoethyl)-gamma-aminopropyltrimethoxysilane, aminopropyltrimethoxysilane, trimethoxymethylsilane. These compounds are commercially available; for example, vinyltrimethoxysilane is available under the trade name Dynasylan® VTMO from Evonik. Such an agent advantageously extends the storage life of the composition of ionic silylated copolyurethanes formed by the process according to the invention, during storage and transportation before its use.

The desiccant is generally introduced at the end of step (iii) in a proportion of an amount expressed as % by weight ranging from 0.5% to 5%, on the basis of the total weight of the reagents used.

According to another variant, the process according to the invention is carried out in the absence of desiccant.

Composition of Ionic Silylated Copolyurethanes:

A subject of the present invention is also, secondly, a composition of ionic silylated copolyurethanes comprising two ureido-alkylene-alkoxysilane end groups, said composition being able to be obtained by means of the preparation process according to the invention.

The two ureido-alkylene-alkoxysilane end groups of said copolyurethanes correspond, respectively, to formulae:

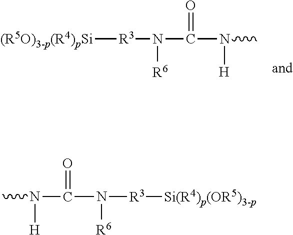

in which R³, R⁴, R⁵, R⁶ and p are as defined above.

Crosslinkable Adhesive and/or Sealant Composition:

A subject of the present invention is also, thirdly, a crosslinkable adhesive and/or sealant composition comprising:
at least one composition of ionic silylated copolyurethanes having ureido-alkylene-alkoxysilane end groups according to the invention, and
at least one filler.

According to one preferred embodiment, the crosslinkable adhesive and/or sealant composition comprises:
from 10% to 50% by weight of said copolyurethane composition, preferably from 20% to 45% by weight, more preferably from 35% to 45% by weight, and
from 20% to 60% by weight of the filler, preferably from 30% to 55% by weight, more preferably from 40% to 55% by weight;

these weight percentages being expressed on the basis of the total weight of said composition.

The filler(s) which can be used in the composition according to the invention can be chosen from mineral fillers and mixtures of organic fillers and of mineral fillers.

As examples of mineral filler(s) which can be used, use may be made of any mineral filler(s) customarily used in the field of adhesive and/or sealant compositions. These fillers are in the form of particles of varied geometry. They may be, for example, spherical or fibrous or may have an irregular shape.

Preferably, use is made of clay, quartz or carbonate fillers.

More preferentially, use is made of carbonate fillers, such as alkali metal or alkaline earth metal carbonates, and more preferentially calcium carbonate.

These fillers can be natural or treated, for example using an organic acid, such as stearic acid, or a mixture of organic acids consisting predominantly of stearic acid.

Use may also be made of hollow mineral microspheres, such as hollow glass microspheres, and more particularly those made of calcium sodium borosilicate or of aluminosilicate.

As examples of organic filler(s) which can be used, use may be made of any organic filler(s) and in particular polymeric filler(s) customarily used in the field of adhesive and/or sealant compositions.

Use may be made, for example, of polyvinyl chloride (PVC), polyolefins, rubber, ethylene/vinyl acetate (EVA) or aramid fibres, such as Kevlar®.

Use may also be made of hollow microspheres made of expandable or non-expandable thermoplastic polymer. Mention may notably be made of hollow microspheres made of vinylidene chloride/acrylonitrile.

Preferably, use is made of PVC.

The mean particle size of the filler(s) which can be used is preferably less than or equal to 10 microns, more preferentially less than or equal to 3 microns, in order to prevent them from settling in the adhesive and/or sealant composition according to the invention during its storage.

The mean particle size is measured for a volume particle size distribution corresponding to 50% by volume of the sample of particles which is analysed. When the particles are spherical, the mean particle size corresponds to the median diameter (D50 or Dv50), which corresponds to the diameter such that 50% of the particles by volume have a size which is smaller than said diameter. In the present application, this value is expressed in micrometers and determined according to standard NF ISO 13320-1 (1999) by laser diffraction on an appliance of Malvern type.

Advantageously, the composition according to the invention does not comprise water as solvent. Thus, the water content in the composition according to the invention is advantageously less than 5% by weight relative to the total weight of said composition, preferably less than 3% by weight, in particular less than 1% by weight.

According to one embodiment, the composition according to the invention may additionally comprise at least a moisture-absorbing agent, an adhesion-promoting agent, a plasticizing agent and/or a rheology agent.

Suitable moisture-absorbing agents (desiccants) are as described above. An amount of moisture-absorbing agents in the composition of between 0.5% and 5% by weight, based on the weight of said composition, will generally be suitable.

Some of these compounds may also act as adhesion-promoting agent, particularly the trialkoxysilanes containing an amino, mercapto or epoxy group. Examples that may be given include:
N-(3-(trimethoxysilyl)propyl)ethylenediamine sold under the name Geniosil® GF9 by Wacker, or else
3-aminopropyltrimethoxysilane sold under the name Silquest A-1110 by Momentive.

An amount of from 0.5% to 2% by weight (based on the weight of said composition) will generally be appropriate.

The plasticizing agents which can be used are also as described above. The plasticizing agent is generally included in the composition according to the invention in an amount of from 5% to 20% by weight, preferably from 10% to 15% by weight, based on the weight of said composition.

The rheology agents which can be used are any rheology agents customarily used in the field of adhesive and/or sealant compositions.

Preferably, use is made of one or more rheology agents chosen from thixotropic agents, and more preferentially from:
PVC plastisols, corresponding to a suspension of PVC in a plasticizing agent which is miscible with PVC, obtained in situ by heating to temperatures ranging from 60° C. to 80° C. These plastisols can be those described in particular in the publication Polyurethane Sealants, Robert M. Evans, ISBN 087762-998-6,
thixotropic polyamides such as Thixatrol® AS8053, available from Elementis,
fumed silica,
urea derivatives resulting from the reaction of an aromatic diisocyanate monomer, such as 4,4′-MDI, with an aliphatic amine, such as butylamine. The preparation of such urea derivatives is described in particular in the application FR 1 591 172.

The total content of rheology agent(s) that may be included in the composition according to the invention may vary from 1% to 40% by weight, preferably from 5% to 30% by weight, more preferentially from 10% to 25% by weight, based on the weight of said composition.

The crosslinkable sealant and/or adhesive composition according to the invention is preferably stored in an anhydrous environment, for example in a hermetic packaging where said composition is protected from moisture and preferably protected from light.

According to one preferred embodiment, the crosslinkable sealant and/or adhesive composition has an elongation at break of greater than 100%. In the present invention, the elongation at break is measured according to standard NF ISO 37 (March 2012), using “dumbbell” type test specimens 20 mm long, 4 mm wide and 3 mm thick.

Preferably, the elongation at break of said composition is greater than or equal to 150%, preferably greater than or equal to 200%.

Process for Preparing the Crosslinkable Sealant and/or Adhesive Composition:

The present invention also relates to a process for preparing a crosslinkable sealant and/or adhesive composition according to the invention, said preparation process comprising a step in which the ingredient(s) possibly present in said composition is (are) mixed with a non-ionic copolyurethane composition according to the invention, generally at a temperature of less than or equal to 50° C., preferably ranging from 5° C. to 45° C., and better still ranging from 20° C. to 30° C.

When, in one variant of the process for producing the composition of ionic silylated copolyurethanes according to the invention, said process is carried out in the absence of plasticizing agent and/or solvent, and/or in the absence of moisture-absorbing agent, said plasticizing agent and/or solvent and/or moisture-absorbing agent are then advantageously introduced during the preparation of the sealant and/or adhesive composition, among the ingredients mixed with said copolyurethane composition. The plasticizing agent, the solvent and the moisture-absorbing agent are as described above.

The addition and the mixing are carried out under anhydrous conditions.

Article Comprising the Crosslinkable Adhesive and/or Sealant Composition:

Another subject of the present invention is an article comprising the crosslinkable adhesive and/or sealant composition according to the invention in a hermetic packaging protected from air. The hermetic packaging is preferably a polyethylene bag or a polyethylene cartridge provided with a cap.

Process for Assembling Two Substrates:

Lastly, the invention relates to a process for assembling two substrates, comprising:
coating the crosslinkable adhesive and/or sealant composition according to the invention at ambient temperature, in the form of a layer of a thickness between 0.2 and 5 mm, preferably between 1 and 3 mm, onto at least one of the two substrates to be assembled; then
effectively bringing the two substrates into contact.

The appropriate substrates are, for example, inorganic substrates, such as glass, ceramics, concrete, metals or alloys (such as aluminium, steel, non-ferrous metals and galvanized metals); or else organic substrates such as wood, plastics, such as PVC, polycarbonate, PMMA, polyethylene, polypropylene, polyesters or epoxy resins; substrates made of metal and composites coated with paint (as in the motor vehicle field).

### EXAMPLES

The examples that follow are given purely by way of illustration of the invention and should not be interpreted in order to limit the scope thereof.

### Example A (Comparative)

1) Preparation of an ionic silylated copolyurethane A having trimethoxysilane end groups:

Step (i): Synthesis of a Copolyurethane Having Isocyanate End Groups

The following are introduced into a 1 litre reactor equipped with a stirrer, heating means and a thermometer and connected to a vacuum pump:
67.34 g of Acclaim® 4200 polypropylene glycol having a hydroxyl number NOH equal to 28 mg KOH/g, corresponding to a number of —OH functions equal to 33.5 mmol;
15 g of Dow Corning® 3074 silsesquioxane; and
0.5 g of DMPA (molar mass equal to 134.13 g/mol) corresponding to a number of —OH functions equal to 7.4 mmol.

The mixture is left under vacuum for 2 hours at 110° C. for dehydration.

The reactor is then cooled to 90° C. in order to introduce, under nitrogen:
7.87 g of isophorone diisocyanate (IPDI) of molar mass equal to 222.3 g/mol, i.e. a number of —NCO functions equal to 70.8 mmol; and
0.15 g of the Borchi® KAT 315 catalyst (bismuth neodecanoate).

The amounts of reactants introduced correspond to an —NCO/—OH molar equivalent ratio equal to 1.73.

The mixture is kept stirring until an NCO weight percentage of 1.7% is reached, corresponding to a number of —NCO functions equal to 30.6 mmol.

Step (ii): Synthesis of an Ionic Copolyurethane Having Isocyanate End Groups

At 40° C., 0.38 g of TriEthylAmine (TEA) (molar mass equal to 101.19 g/mol), i.e. 3.75 mmol, is then introduced into the reaction medium and the mixture is left stirring for 1 hour.

Step (iii): Synthesis of the Ionic Silylated Copolyurethane

Lastly, 7.2 g of the aminosilane (N-(3-(trimethoxysilyl)propyl)butylamine) (Dynasylan® 1189) of molar mass equal to 235.4 g/mol, corresponding to a number of —NH-functions equal to 30.6 mmol, is added to the reaction medium.

The —NCO/—NH— molar equivalent ratio is equal to 1.

The combined mixture is heated to 40° C. and kept stirring until the reaction is complete, i.e. until the band characteristic of the —NCO functions is no longer detectable by infrared spectroscopy.

1 g of vinyltrimethoxysilane (VTMO) is then added.

100 g of a mixture consisting of approximately 84 g of ionic silylated copolyurethane, 15 g of Dow Corning® 3074 silsesquioxane and 1 g of VTMO are obtained. This mixture is packaged in aluminium cartridges protected from moisture.

2) Preparation of a Sealant Composition A Comprising the Ionic Silylated Copolyurethane A Obtained in 1):

Sealant A is prepared by simple mixing in a rapid mixer, the composition of sealant A being indicated hereinbelow on a weight basis:
38.11% by weight of the ionic silylated copolyurethane A mixture obtained above;
45.18% by weight of precipitated calcium carbonate with a mean particle size of less than 1 μm (Calofort SV, available from Specialty Minerals);
9.6% by weight of ground calcium carbonate with a mean particle size of approximately 3 μm (Immerseal 36 S, available from Imerys);
3.28% of a thixotropic polyamide (Thixatrol AS8053, available from Elementis);
2.83% by weight of vinyltrimethoxysilane (VTMO), as moisture-absorbing agent;
1% by weight of 3-aminopropyltrimethoxysilane (sold under the name Silquest A-1110 by Momentive) as adhesion promoter.

The sealant composition obtained is left stirring under a reduced pressure of 20 mbar for 15 minutes before being packaged in a polyethylene cartridge to avoid the presence of moisture.

The composition is then subjected to the following tests.

Measurement of the Crosslinking Time:

The crosslinking time is measured by determining the skinning time.

To this end, a bead of sealant (approximately 10 cm long and approximately 1 cm in diameter) is first deposited on a cardboard support. Then, using the tip of a pipette made from low-density polyethylene (LDPE), the surface of the sealant is touched every minute for a maximum of 2 hours in order to determine the exact time at which the skin forms on the surface. This test is performed under controlled conditions of humidity and temperature (23° C. and 50% relative humidity).

The result obtained is expressed in minutes and indicated in Table 2.

Measurement of the Breaking Stress and the Elongation at Break by Tensile Testing:

The principle of the measurement consists in drawing, in a tensile testing device, the movable jaw of which moves at a constant rate equal to 100 mm/minute, a standard test specimen consisting of the crosslinked sealant composition and in recording, at the moment when the test specimen breaks, the tensile stress applied (in MPa) and also the elongation of the test specimen (in %).

The standard test specimen is dumbbell-shaped, as illustrated in International Standard ISO 37. The narrow part of the dumbbell used has a length of 20 mm, a width of 4 mm and a thickness of 3 mm.

To prepare the dumbbell, the composition packaged as described above is extruded at ambient temperature into an appropriate mould and is left to crosslink for 14 days under standard conditions (23° C. and 50% relative humidity).

This determination is repeated over 5 dumbbells and the mean obtained is indicated in Table 2.

### Examples 1-5 (According to the Invention)

1) Preparation of a Composition of Ionic Silylated Copolyurethanes Having Trimethoxysilane End Groups:

The process of example A is repeated with, in step (i), the Acclaim® 4200 being replaced with Voranol® EP1900, Voranol® P2000 and Terathane® 650 in the amounts indicated by weight in Table 1, and, for the other reagents and ingredients, the weights also indicated in Table 1.

2) Preparation of a Sealant Composition Comprising the Composition of Silylated Copolyurethanes Obtained in 1):

This sealant is prepared by repeating example A 2), except that the ionic silylated copolyurethane A is replaced with the composition of silylated copolyurethanes obtained in 1).

The results are indicated in Table 2.

TABLE 1
Preparation of ionic silylated copolyurethanes having trimethoxysilane end groups

| | | Ex. A | | | | | |
|---|---|---|---|---|---|---|---|
| Step | Ingredients | (comp.) | Ex. 1 | Ex. 2 | Ex. 3 | Ex. 4 | Ex. 5 |
| (i) | Acclaim ® 4200 (in g) | 67.34 | — | — | — | — | — |
| | Voranol ® EP1900 (B1, in g) | — | 55.81 | 47.58 | 40.20 | 39.83 | 32.33 |
| | Voranol ® P2000 (B2-1, in g) | — | 13.95 | 13.59 | 16.75 | 13.30 | 12.93 |
| | Terathane ® 650 (B2-2, in g) | — | — | 6.80 | 10.10 | 13.30 | 19.40 |
| | B1/(B1 + B2) (mol %) | — | 67% | 41% | 29% | 27% | 18% |
| | B2/(B1 + B2) (mol %) | — | 33% | 59% | 71% | 73% | 82% |
| | Dow Corning ® 3074 (in g) | 15 | 15 | 15 | 15 | 15 | 15 |
| | DMPA (in g) | 0.5 | 0.5 | 0.5 | 0.5 | 0.5 | 0.5 |
| | DMPA/Acclaim ® 4200 or | 0.19 | 0.18 | 0.13 | 0.11 | 0.10 | 0.084 |
| | DMPA/(B1 + B2) molar ratio | | | | | | |
| | IPDI (in g) | 7.87 | 8.01 | 9.80 | 10.81 | 11.49 | 13.11 |
| | Borchi ® KAT 315 (in g) | 0.15 | 0.15 | 0.15 | 0.15 | 0.15 | 0.15 |
| | —NCO/—OH | 1.73 | 1.5 | 1.4 | 1.3 | 1.3 | 1.2 |
| | equivalent molar ratio | | | | | | |
| (ii) | TEA (in g) | 0.38 | 0.38 | 0.38 | 0.38 | 0.38 | 0.38 |
| | TEA/DMPA | 1.00 | 1.00 | 1.00 | 1.00 | 1.00 | 1.00 |
| | equivalent molar ratio | | | | | | |
| (iii) | Dynasylan ® 1189 (in g) | 7.2 | 5.24 | 5.24 | 5.24 | 5.24 | 5.24 |
| | —NCO/—NH— molar | 1 | 1 | 1 | 1 | 1 | 1 |
| | equivalent ratio | | | | | | |
| | VTMO (in g) | 1 | 1 | 1 | 1 | 1 | 1 |

TABLE 2
Results relating to the silylated sealants

| | Ex. A | Ex. 1 | Ex. 2 | Ex. 3 | Ex. 4 | Ex. 5 |
|---|---|---|---|---|---|---|
| Crosslinking | 30 | 20 | 40 | 35 | 30 | 28 |
| time (min) | | | | | | |
| Tensile test - | 4 | 3.0 | 3.4 | 3.2 | 3.8 | 3.5 |
| Breaking | | | | | | |
| stress (MPa) | | | | | | |
| Tensile test - | 85 | 180 | 160 | 250 | 280 | 245 |
| Elongation | | | | | | |
| at break (%) | | | | | | |

### Examples 6-9 (According to the Invention)

The process for preparing the composition of ionic silylated copolyurethanes having trimethoxysilane end groups of Example 4 is repeated with the TEA being replaced, in step (ii), with the amine indicated in Table 1′. The amounts of the reagents and ingredients used are shown in Table 1′.

The preparation of the sealant of Example A 2) is also repeated with the copolyurethane compositions thus obtained. The results are indicated in Table 2′.

It emerges from these results tables that the compositions of ionic silylated copolyurethanes according to Examples 1 to 9 make it possible, entirely advantageously compared to the ionic silylated copolyurethane of Example A, to obtain silylated sealants which, for a comparable crosslinking time, provide an adhesive seal with an entirely acceptable breaking strength (in the vicinity of 3 Mpa) and the elongation at break of which (greater than 150%) is very significantly increased compared to the silylated sealant corresponding to Example A.

TABLE 1′
Preparation of ionic silylated copolyurethanes
having trimethoxysilane end groups

| Step | Ingredients | Ex. 6 | Ex. 7 | Ex. 8 | Ex. 9 |
|---|---|---|---|---|---|
| (i) | Voranol ® EP1900 | 39.65 | 39.71 | 39.77 | 39.54 |
| | (B1, in g) | | | | |
| | Voranol ® P2000 | 13.22 | 13.24 | 13.26 | 13.18 |
| | (B2-1, in g) | | | | |
| | Terathane ® 650 | 13.22 | 13.24 | 13.26 | 13.18 |
| | (B2-2, in g) | | | | |
| | Dow Corning ® 3074 | 15 | 15 | 15 | 15 |
| | (in g) | | | | |
| | B1/(B1 + B2) | 27 | 27 | 27 | 27 |
| | (mol %) | | | | |
| | B2/(B1 + B2) | 73 | 73 | 73 | 73 |
| | (mol %) | | | | |
| | DMPA (in g) | 0.5 | 0.5 | 0.5 | 0.5 |
| | DMPA/(B1 + B2) | 0.10 | 0.10 | 0.10 | 0.10 |
| | molar ratio | | | | |
| | IPDI (in g) | 11.46 | 11.45 | 11.5 | 11.43 |
| | Borchi ® KAT 315 (in g) | 0.15 | 0.15 | 0.15 | 0.15 |
| | —NCO/—OH | 1.27 | 1.27 | 1.27 | 1.27 |
| | equivalent molar ratio | | | | |
| (ii) | DCHMA (in g) | 0.73 | | | |
| | DBU (in g) | | 0.57 | | |
| | DABCO (in g) | | | 0.42 | |
| | THA (in g) | | | | 1.01 |
| | amine/DMPA | 1 | 1 | 0.9 | 1 |
| | equivalent molar ratio | | | | |
| (iii) | Dynasylan ® 1189 | 5.22 | 5.23 | 5.23 | 5.2 |
| | (in g) | | | | |
| | —NCO/—NH— molar | 1 | 1 | 1 | 1 |
| | equivalent ratio | | | | |
| | VTMO (in g) | 1 | 1 | 1 | 1 |

TABLE 2′
Results relating to the silylated sealants

| | Ex. 6 | Ex. 7 | Ex. 8 | Ex. 9 |
|---|---|---|---|---|
| Crosslinking time (min) | 15 | 35 | 35 | 28 |
| Tensile test - | 3.5 | 2.8 | 3.2 | 3.3 |
| Breaking stress (MPa) | | | | |
| Tensile test - | 255 | 315 | 285 | 295 |
| Elongation at break (%) | | | | |

1. Process for preparing a composition of ionic silylated copolyurethanes comprising two ureido-alkylene-alkoxysilane end groups, said process comprising successively:
a step (i) of forming a composition of copolyurethanes having —NCO end groups by carrying out a polyaddition reaction between:
a polyisocyanate (A) of formula (iA):
OCN—R¹—NCO (iA)
in which R¹ represents a divalent hydrocarbon radical comprising from 5 to 45 carbon atoms and which may be aromatic or aliphatic, linear, branched or cyclic, and may include at least one heteroatom selected from the group consisting of O, S and N;
a composition (B) of polyols comprising:
at least one polyol (B1) with a number-average molecular mass (Mn) of greater than or equal to 2500 g/mol; and
at least one polyol (B2) with a number-average molecular mass (Mn) of less than 2500 g/mol; and
a carboxylic diol (C) of formula (iC): 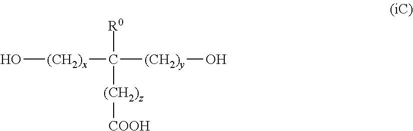
in which:
R⁰ represents a hydrogen atom or an alkyl radical comprising from 1 to 18 carbon atoms;
x and y, which may be identical or different, are integers ranging from 1 to 8; and
z is an integer ranging from 0 to 8; then
a step (ii) of reacting the composition of copolyurethanes formed in step (i) with an amine (D) of formula (iiD):
N(R)(R′R″) (iiD)
in which:
R, R′ and R″, which may be identical or different, each represent a saturated, unsaturated or aromatic hydrocarbon radical, optionally comprising a heteroatom selected from the group consisting of N, O and S;
R, R′ and R″ furthermore being such that said tertiary amine (D) is a linear, branched or cyclic amine or polyamine the number-average molar mass Mn of which ranges from 59 to 6000 g/mol and which has a pKa of greater than 8; then
a step (iii) of reacting the composition of copolyurethanes having —NCO end groups formed in step (ii) with an aminosilane (E) derived from a secondary amine, of formula (iiiE): 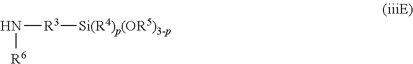
in which:
R³ represents a linear or branched divalent alkylene radical comprising from 1 to 6 carbon atoms;
R⁴ represents a linear or branched alkyl radical comprising from 1 to 4 carbon atoms;
R⁵ represents a linear or branched alkyl radical comprising from 1 to 4 carbon atoms, an alkylcarbonyl radical comprising from 2 to 8 carbon atoms, or a dialkylimino radical comprising from 3 to 8 carbon atoms; and
p is an integer equal to 0, 1 or 2;
R⁶ represents a phenyl radical, a linear, branched or cyclic alkyl radical comprising from 1 to 6 carbon atoms, or a radical selected from the group consisting of the radicals:
of formula (IIc): 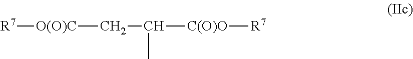
of formula (IId): 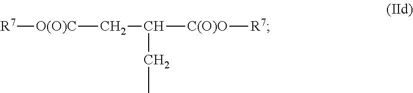
of formula (IIe): 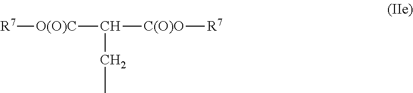
in which R⁷ is a linear or branched alkyl radical comprising from 1 to 6 carbon atoms;
of formula (IIf):
—CH₂—COO⁻, HN⁺(R)(R′)(R″) (IIf); and
of formula (IIg):
—CH₂—CH₂—COO⁻, HN⁺(R)(R′)(R″) (IIg)
in which R, R′ and R″ are as defined above.

2. The process according to claim 1, characterized in that the radical R¹ of the polyisocyanate (A) used in step (i) is chosen from:
a) the divalent radical derived from isophorone diisocyanate (IPDI): 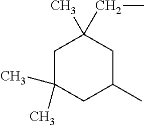
b) the divalent radical derived from dicyclohexylmethane 4,4′- and 2,4′-diisocyanate (HMDI): 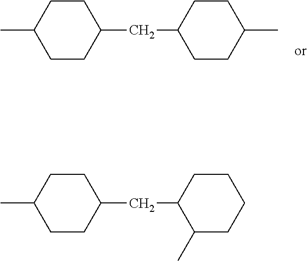
c) the radical derived from toluene 2,4- and 2,6-diisocyanate (TDI): 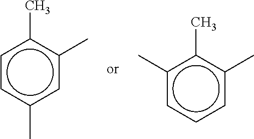
d) the radical derived from diphenylmethane 4,4′- and 2,4′-diisocyanate (MDI): 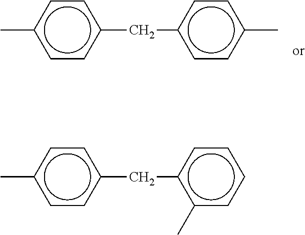
e) the radical derived from m-xylylene diisocyanate (m-XDI): 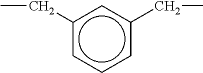
f) the radical derived from hexamethylene diisocyanate (HDI):
—(CH₂)₆—
g) the divalent group derived from a hexamethylene diisocyanate (HDI) allophanate of formula (iA′): 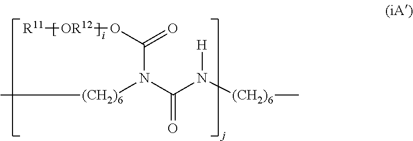
in which:
i is an integer ranging from 2 to 5;
j is an integer ranging from 1 to 2;
R¹¹ represents a saturated or unsaturated, cyclic or acyclic, linear or branched hydrocarbon radical comprising from 6 to 14 carbon atoms;
R¹² represents a divalent propylene group;
i, j, R¹¹ and R¹² being such that the hexamethylene diisocyanate allophanate corresponding to the formula (iA′) comprises a content of isocyanate groups NCO ranging from 12% to 14% by weight, relative to the weight of said allophanate.

3. The process according to claim 1, characterized in that the number-average molecular mass Mn of the polyol (B1) included in the composition (B) used in step (i) is within a range extending from 2500 g/mol to 20000 g/mol and/or the number-average molecular mass Mn of the polyol (B2) included in the composition (B) used in step (i) is within a range extending from 200 to 2250 g/mol.

4. The process according to claim 1, characterized in that the polyol composition (B) comprises from 10 mol % to 35 mol % of the polyol (B1) and from 65 mol % to 90 mol % of the polyol (B2), said mole percentages being expressed on the basis of the total number of moles of (B1) and (B2) present in the composition (B).

5. The process according to claim 1, characterized in that the polyol composition (B) comprises, besides the polyol (B1), two polyols (B2) chosen, respectively, from:
a first polyol (B2-1) having a number-average molecular mass Mn of greater than or equal to 1250 g/mol and less than 2500 g/mol, and
a second polyol (B2-2) with a number-average molecular mass (Mn) ranging from 200 g/mol to 1000 g/mol.

6. The process according to claim 1, characterized in that the polyols included in the composition (B) have a hydroxyl functionality equal to 2.

7. The process according to claim 1, characterized in that the polyols included in the composition (B) are polyether diols.

8. The process according to claim 1, characterized in that the carboxylic diol (C) used in step (i) has the formula (iC) in which:
R⁰ represents an alkyl radical comprising from 1 to 4 carbon atoms, preferably a methyl, ethyl or n-propyl radical, even more preferentially a methyl radical;
x and y are identical and equal to 1; and/or
z is equal to 0.

9. The process according to claim 1, characterized in that the tertiary amine (D) used in step (ii) is selected from the group consisting of:
a polyethyleneimine,
a polypropyleneimine,
triethylamine,
1,8-diazabicyclo[5.4.0]undec-7-ene (or DBU) having the structural formula: 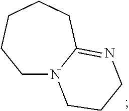 [SMILES: C1CCC2=NCCCN2CC1]
1,4-diazabicyclo[2.2.2]octane (or DABCO), having the structural formula: 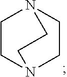
1,5-diazabicyclo[4.3.0]non-5-ene (or DBN), having the structural formula: 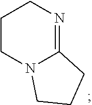
N,N-dicyclohexylmethylamine (or DCHMA); and
trihexylamine (or THA).

10. The process according to claim 1, characterized in that the aminosilane (E) used in step (iii) has the formula (iiiE) in which:
R³ represents the methylene or n-propylene radical;
R⁴ and R⁵, which may be identical or different, each represent the methyl or ethyl radical;
p is equal to 0; and/or
R⁶ represents a linear alkyl radical comprising from 1 to 4 carbon atoms or a radical of formula (IIc) in which R⁷ is an alkyl radical comprising from 1 to 3 carbon atoms.

11. The process according to claim 1, characterized in that it is carried out in the presence of a plasticizing agent and/or a solvent that is not water.

12. Composition of ionic silylated copolyurethanes comprising two ureido-alkylene-alkoxysilane end groups, said composition being able to be obtained by means of the preparation process as defined in claim 1.

13. Crosslinkable adhesive and/or sealant composition comprising:
at least one composition of ionic silylated copolyurethanes having ureido-alkylene-alkoxysilane end groups as defined in claim 12, and
at least one filler.

14. Article comprising the crosslinkable adhesive and/or sealant composition as defined in claim 13, in a hermetic packaging protected from air.

15. Process for assembling two substrates, comprising:
coating the crosslinkable adhesive and/or sealant composition as defined in claim 13, at ambient temperature, in the form of a layer of a thickness between 0.2 and 5 mm, onto at least one of the two substrates to be assembled; then
effectively bringing the two substrates into contact.
